(19) United States
(12) Patent Application Publication
(10) Pub. No.: US 2018/0354084 A1
(43) Pub. Date: Dec. 13, 2018

(54) Machine Tool For The Machining Of A Workpiece By Means Of A Tool

(71) Applicant: DECKEL MAHO Pfronten GmbH, Pfronten (DE)

(72) Inventors: Alfred Geissler, Pfronten (DE); Robert Jung, Pfronten (DE)

(21) Appl. No.: 16/002,632

(22) Filed: Jun. 7, 2018

(30) Foreign Application Priority Data
Jun. 12, 2017 (DE) 10 2017 209 845.7

(51) Int. Cl. B23Q 3/155

(52) U.S. Cl. CPC B23Q 3/15513; B23Q 3/15503

(57) ABSTRACT

The invention relates to a machine tool for the machining of a workpiece by means of a tool, wherein the machine tool is designed to clamp the tool for the machine-controlled machining within a machining program on the work spindle and to clamp the tool on the machine bench of the machine tool, characterized by a tool magazine which can be secured on the machine bench, on which a tool or a plurality of tools may be clamped individually in a replaceable manner.

### BACKGROUND

The invention relates to a machine tool for the machining of a workpiece by means of a tool, wherein the machine tool is designed to clamp the workpiece for the machine-controlled machining within a machining program on the work spindle and to clamp the tool on the machine bench of the machine tool.

Such a machine tool of the applicant is described in the European patent EP 2 269 770. It serves for the machining of gears, such as ring gears, pinions or bevel gears on a 5-axis machine tool with a tooth form cutter head, which is fastened on the machine bench. This machine is especially suited for a consecutive machining of a plurality of workpieces on a machine tool, in which only one tool or at least only a few tools are needed for the machining of the individual workpieces. For this purpose, the machine tool has a tool clamping means, which is suited to clamping the tool on the rotary table of the machine tool, especially to clamping the tool on the rotary table firmly against rotation, the rotary table being designed to drive in rotation the tool clamped by the clamping means. Thus, the rotational motion of the workpiece is realized directly by the movement of the rotary table. The clamping means may also be designed as a tool device which comprises a machining means for the machining of a workpiece, i.e., a tool, and a driving means for driving the machining means. In this way, milling as well as drilling work can be carried out.

The machine tool described in the above cited patent is thus suited in particular to the machining of gears by methods known in the prior art, such as the Gleason or the Klingelnberg method with a milling/turning machine tool or a universal machining center.

In present-day machine tool-controlled fabrication of structural parts, fabrication efficiency is a critical factor, especially in the fabrication of machine parts with complex geometry.

The problem which the present invention proposes to solve is therefore to indicate a machine tool and a method for the machining of a workpiece on a machine tool whereby the above described principle of “reverse clamping of workpiece and tool” can be expanded in regard to fabrication efficiency.

### SUMMARY

The problem is solved by a machine tool with the features of patent Claim 1 and a method for the machining of a workpiece on a machine tool with the features of patent Claim 11.

Advantageous embodiments of the invention are indicated by the subject matter of the dependent claims.

The invention provides a machine tool for the machining of a workpiece by means of a tool, which is designed to clamp the workpiece for the machine-controlled machining within a machining program on the work spindle and to clamp the tool on the machine bench of the machine tool, being known as the generic machine from the above described prior art.

According to the invention, a tool magazine is provided on the machine bench of the machine tool, which can be secured on the machine bench and on or at which a tool or a plurality of tools individually in a replaceable manner. For this purpose, the tool magazine according to the invention has clamping means which can be used to clamp different tools individually.

With these clamping means, tools can be changed individually on the tool magazine according to the invention, without the tool magazine having to be removed from the machine bench. At the same time, however, the tool magazine according to the invention also makes possible a joint replacement of a plurality of tools in that the tool magazine is removed from the machine bench and replaced with a different tool magazine.

In other words, the basic concept of the present invention is not simply to provide a clamping means on a machine bench by which tools can be clamped, but rather to modify the tool interface such that it comprises on the one hand the clamping means and on the other hand a storage/carrier which can be mounted directly on the machine bench, serving for the clamping of the workpiece during the traditional use of the machine tool. In this way, this expanded tool interface can be given a greatly enlarged functionality, since it is possible for example to clamp multiple tools, and also to utilize an existing drive mechanism of the bench and/or additional drive mechanisms which are integrated in this tool interface (tool magazine). Furthermore, a premounting of the tools on the expanded interface (tool magazine) is possible, so that a kind of anticipated clamping of the tool becomes possible, since the fastening of the tool magazine (i.e., the expanded tool interface) on the machine bench can be done in a different way from the clamping of the tool itself.

In this way, the concept of the “reverse clamping” of tool and workpiece, as is known for example from the above described prior art of the applicant, can be significantly broadened, since furthermore a plurality of different tools can be provided jointly or separately in time on the machine bench by the tool magazine according to the invention. The plurality of clamping means makes it possible to provide milling, drilling, turning and/or grinding tools on the machine bench at the same time thanks to the tool magazine according to the invention. In this way, a tool clamped on the work spindle may undergo different machining in immediate succession in time, such as drilling, milling, grinding and/or turning. This significantly increases the variability of the machining, especially in a predetermined time interval.

One particular benefit of the tool magazine according to the invention is that it makes it possible to provide the most varied of tools at the same time, while almost no (additional) traverses need to be realized for the use of these different tools, since the different tools are provided jointly by the tool magazine. A further major benefit of the tool magazine according to the invention is that the clamped tools can be placed on or removed from the machine bench at the same time with the tool magazine. In this way, otherwise typical and time-intensive changing processes formerly required for replacing new tools on the work spindle can be avoided and the required cycle times can be reduced by several orders of magnitude.

The tool magazine according to the invention may have various structures. In the most elementary case, it may have a simple pallet. In one preferred exemplary embodiment, it is designed so that different tools can be clamped in different directions on the tool magazine. This is especially expedient when milling, grinding, drilling and/or turning tools are clamped jointly, since in this way the necessary orientation of the tool relative to the workpiece clamped in the work spindle required for the different machining processes can be realized in a simple manner. For this purpose, the tool magazine according to the invention may for example have a substantially rectangular or cuboidal base body, on whose outer surfaces, for example, clamping means are provided for the clamping of a tool. The geometry of the base body necessarily dictates a different orientation of the different tools which can be mounted on the different sides of the base body by the clamping means. Of course, the cuboidal or rectangular geometry is only an example here and the base body may have any other geometry making possible an optimized orientation of the tools clamped on the tool magazine according to the invention. However, the cuboidal or rectangular geometries are especially advantageous because they make possible in simple fashion an orientation of the longitudinal axes of the tools in the form of a right-angled coordinate system, which increases the spatial freedom in the individual machining of the workpiece by the different tools clamped on the tool magazine according to the invention, so that possible collisions of the workpiece clamped on the work spindle with the tools clamped in the tool magazine according to the invention, especially when there are multiple large tools, can be prevented in particular.

An especially advantageous embodiment of the machine tool according to the invention with the tool magazine mounted on the machine bench results when the machine bench is designed as a swivel rotary table. In this way, the orientation of the tool in relation to the workpiece can also be changed by tilting or swiveling the bench, so that new degrees of freedom result in regard to the possible orientation of the tool and especially the traverses required by this, making possible shorter traverses, and also significantly broadening the range of possible orientations of the tool in relation to the workpiece. This is especially of decisive advantage in the machining of complex miniature geometries, as regards the time efficiency. It will be immediately evident that especially the combination of a tool magazine according to the invention, making possible a clamping of the tools in different directions, with a swivel rotary table further greatly expands the range of possible orientations and traverses. Especially in the fully automated fabrication of parts which are removed from a workpiece storage, the machining times can be significantly shortened in this way, especially when a drilling, grinding or turning needs to be done in addition to the milling.

In one preferred embodiment of the tool magazine according to the invention, it comprises separate driving means, making possible a driving of individual or multiple tools independently of the movement of the machine bench. The driving means is advisedly provided inside the base body of the tool magazine according to the invention and it may take place for example by belts, etc. An optionally adjustable gearing may be provided, in order to adapt appropriately the transmission ratio of the drive. In one expedient embodiment, the tool magazine according to the invention is designed for example as a revolver, by means of which the tools can be accordingly driven and/or changed. In this way, besides the driving via the machine bench, there is the additional possibility of integrating a further drive with different speed and transmission ratio in the tool magazine according to the invention. This also greatly increases the application possibilities of different tools, since naturally different tools require different speeds and torques.

The driving means need not necessarily serve only for the driving of the tool, but also it may be designed to change the relative position of the tool in relation to the workpiece, for example in that the revolver is rotated or a tool magazine configured as a cuboid or cube is turned through for example 90° or any other given angle to move another tool into a machining position on the work spindle.

In exemplary embodiments in which the tool magazine according to the invention is integrated on a pallet or itself designed in the form of a pallet, in one expedient exemplary embodiment of the machine tool according to the invention a pallet changer is provided, by means of which the tools clamped on the pallet can be replaced by other pallets, which may likewise be equipped with the tool magazine according to the invention. Advantageously, a round or linear storage will likewise be used for this, in order to swap the pallets in the context of an automated changing of a plurality of tools which are preclamped on the pallets. In this way it becomes possible to swap a plurality of tools in the machine tool according to the invention in an unprecedented short time, so that the possibilities for a workpiece machining in a given time frame are improved by an order of magnitude, since no tool changes need to be done.

A further shortening of the process times when machining several workpieces in series results for the machine tool according to the invention by the use of a wheel magazine, which can be designed to store a plurality of workpieces and/or tools, as well as a changing mechanism (such as a manipulator or the like) by means of which the workpieces can be swapped in and out from the wheel magazine into the work spindle and/or the tool magazine.

Basically, the invention is not confined to the use of a wheel magazines. It is also possible to use chain magazines or other customary magazines if advisable and if available. However, it is critical that these be designed to contain workpieces. A wheel magazine offers the benefit here that even large workpieces can be held, since there is sufficient room along the peripheral surface of the wheel. In this context, it is possible to not occupy every receiving space on the wheel magazine when the workpieces are large.

In another embodiment of the machine tool according to the invention the wheel magazine may likewise be configured to hold tools and the changing mechanism is moreover configured to swap not only the workpieces but also tools in and out from the wheel magazine to the work spindle. In a similar manner, both the tool magazine according to the invention and the work spindle may be designed to have corresponding clamping means both for tools and for workpieces. This may be, for example, conventional tool interfaces, such as HSK (hollow shaft cone) interfaces or the like. Using appropriate tool interfaces, the workpiece may also be held in a similar fashion to a tool in the work spindle. In this way, a high degree of variability is ensured.

In other words, the machine tool according to the invention is preferably designed to provide both tools and workpieces both on the machine bench (via the tool magazine according to the invention), and in a corresponding magazine, such as the above described wheel magazine. In this way, the highest possible variability is realized with greatly minimized traverses of both workpiece and tool when changing the tool and workpiece from the machine tool according to the invention.

The invention furthermore involves a method for the machining of a workpiece on a machine tool with the steps: providing of a plurality of workpieces in a magazine, swapping of one of the workpieces in the work spindle of the machine tool, providing of a tool magazine with an individual tool or a plurality of tools, mounted on a machine bench of the machine tool, and machining of the workpiece clamped in the work spindle with one of the tools kept in the tool magazine.

The method according to the invention enables a machining of a plurality of workpieces in short succession with short changing and traversing times in various ways. One special benefit of the method according to the invention is that different machining steps, such as turning, grinding, drilling, and milling, can also be performed by tools which are clamped together in the tool magazine.

This is accomplished by an embodiment of the method according to the invention in which a workpiece clamped in the work spindle is machined by various tools stored in the tool magazine, wherein at least two tools are used from the group of milling, grinding, turning and drilling.

In one especially advantageous embodiment of the method according to the invention, not only tools but also workpieces are clamped in the tool magazine, so that machining can be done with a machine tool configuration in which tool and workpiece are alternately present in work spindle or tool magazine.

A major advantage of the solution according to the invention thus lies in the realization of the understanding that, by providing tools thanks to the tool magazine according to the invention in the region of the machine bench, different machining steps can be carried out by different tools without requiring corresponding change processes and/or costly traversing of the tools for positioning in the machining position on the workpiece.

### BRIEF DESCRIPTION OF THE DRAWINGS

Further details of the present invention will be described below with the aid of specific exemplary embodiments making reference to the figures, where

FIG. 1a shows a first exemplary embodiment of a machine tool according to the invention with tool magazine according to the invention and wheel magazine in spatial representation,

FIG. 1b illustrates an enlarged feature of FIG. 1a, showing a workpiece fastened to the work spindle and a turning tool fastened to the tool magazine,

FIG. 1c shows a side view of a feature of the machine tool according to the invention as shown in FIG. 1a,

FIG. 2a shows another configuration of a machine tool according to the invention, in which a workpiece secured to the work spindle is subjected to a drilling in the vertical direction,

FIG. 2b shows another configuration of a machine tool according to the invention, in which a workpiece secured to the work spindle is subjected to a turning in the horizontal direction,

FIG. 2c shows another configuration of a machine tool according to the invention, in which a workpiece secured to the work spindle is subjected to a drilling in the horizontal direction,

FIG. 3a shows an exemplary embodiment of a machine tool according to the invention wherein a tool magazine according to the invention is arranged on a pallet which is carried by a NC circular table,

FIG. 3b shows another exemplary embodiment of a machine tool according to the invention wherein the machine bench is designed as a swivel rotary table, the swivel rotary table being shown in a recumbent position A=0°,

FIG. 3c shows another exemplary embodiment of a machine tool according to the invention wherein the machine bench is designed as a swivel rotary table, the swivel rotary table being shown in a recumbent position A=90°,

FIG. 4a shows another exemplary embodiment of the machine tool according to the invention wherein the tool magazine is mounted on a pallet and a pallet changer is provided for it,

FIG. 4b shows a round magazine for holding a plurality of pallets for swapping in a machine tool according to the invention, and

FIG. 5 shows a flow chart of an exemplary embodiment of a method according to the invention for the machining of a workpiece on a machine tool.

### DETAILED DESCRIPTION

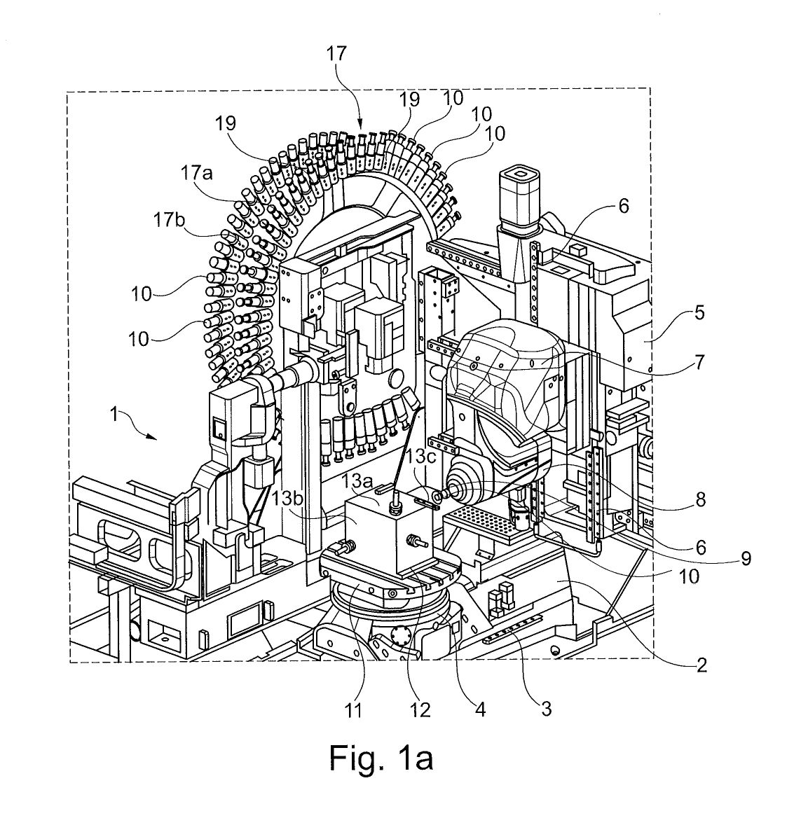

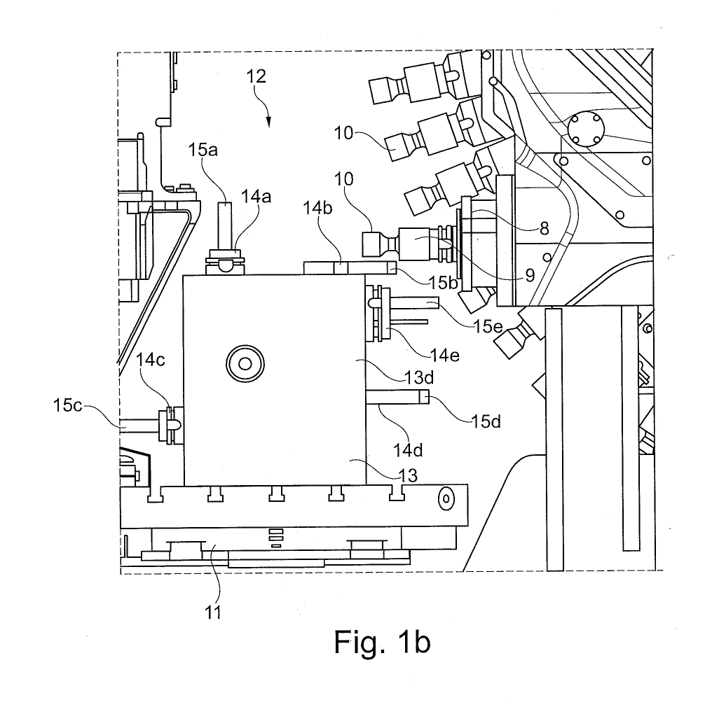

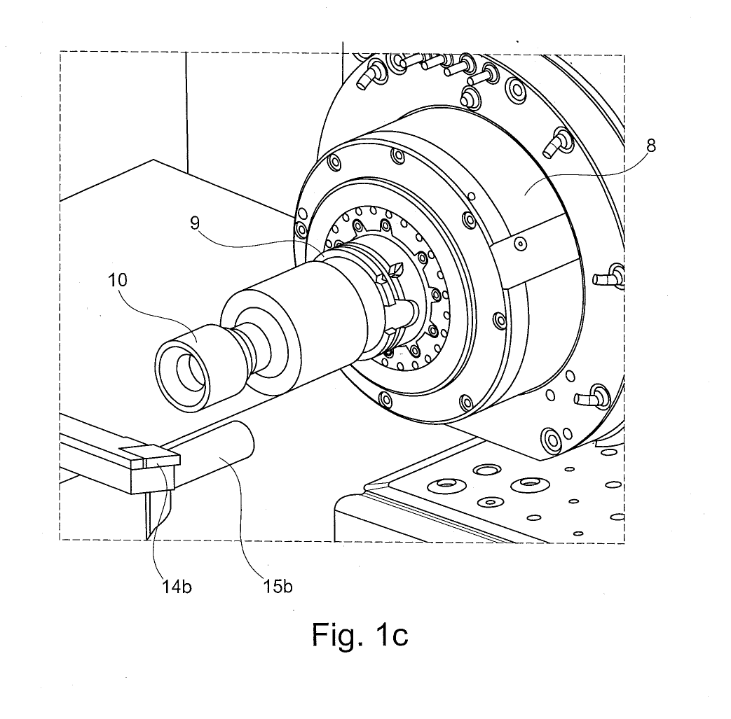

FIG. 1a shows the exemplary embodiment of a machine tool according to the invention in perspective representation. The machine tool 1 comprises a machine bed 2, on which a machine bench 4 is mounted in guideways 3. The machine frame of the machine tool 1 according to the invention furthermore comprises a vertical pillar 5, on which guides 6 are arranged, by which a work spindle 7 can be moved in the vertical direction. The work spindle 7 comprises a spindle head 8, in which a HSK interface 9 (see FIG. 1b) is supported, by means of which a workpiece 10 is clamped in the work spindle 7.

On the machine bench 4 there is arranged a pallet 11 with a tool magazine 12, being mounted firm against rotation on the pallet 11. The tool magazine 12 has a rectangular base body 13, on whose sides, or surfaces 13a, 13b and 13c (FIG. 1a), are provided clamping means 14a, 14b, 14c, 14d, 14e and 14f, in which tools 15a are clamped in various directions.

The tools 15b and 15d here are turning tools, while the tools 15a, 15c, 15e and 15f are designed as drilling tools. However, the invention is not limited to this and milling tools or grinding tools could also be held in the tool magazine 2.

The machine tool 1 according to the invention furthermore comprises a wheel magazine 17 with two cascaded wheels 17a and 17b, which provide along their circumference a plurality of workpieces 10 in corresponding workpiece stations 19. A handling device in the form of a changer 22 is provided in order to swap out the individual workpieces 10 from the workpiece stations 19 of the wheel magazine 17 and replace them in the spindle head 8.

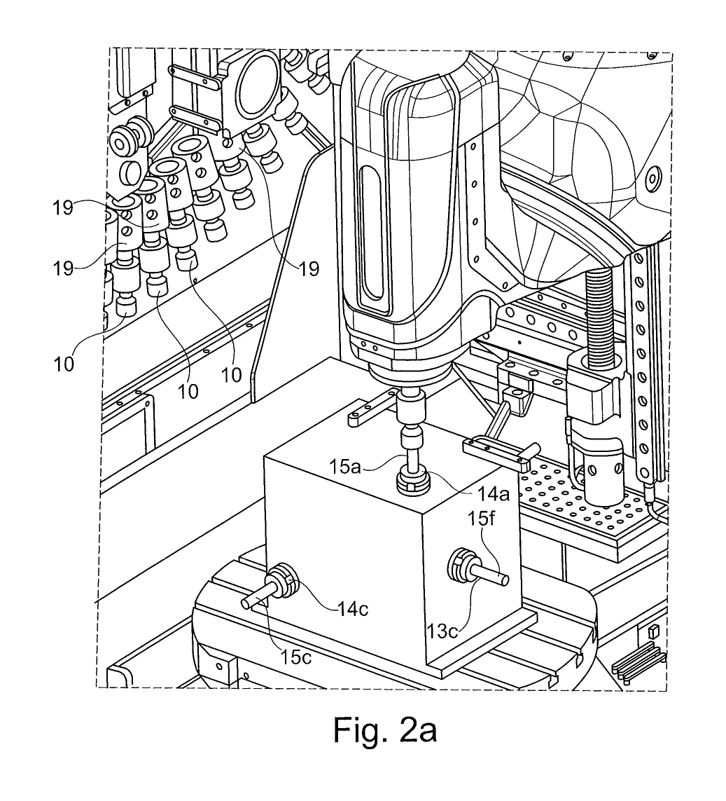

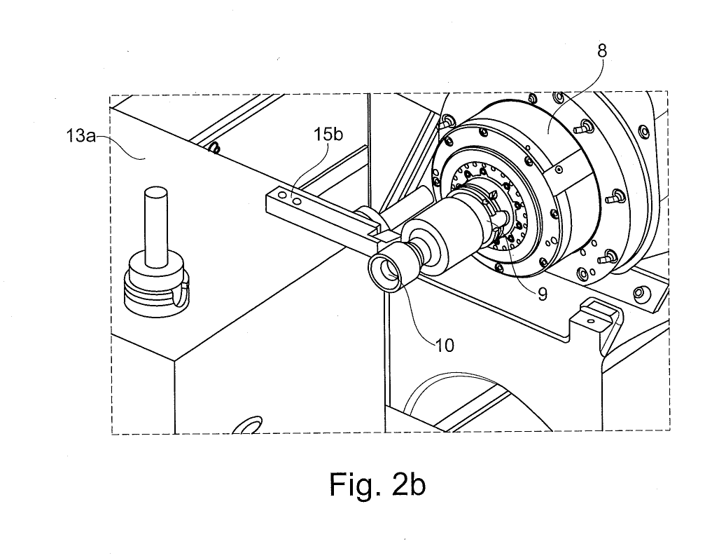

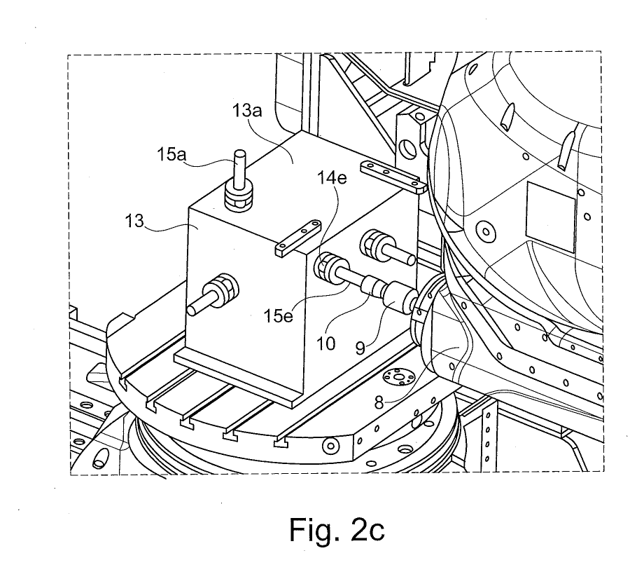

FIGS. 2a to 2c illustrate various machining processes of the workpiece 10 clamped in the spindle head 8 by means of the HSK interface 9. The representations show that different kinds of machining can be done for the tool magazine 12 according to the invention with the tools 15a to 15e oriented in different directions. Thus, for example, FIG. 2a illustrates a drilling of the workpiece in the vertical direction and FIG. 2b a turning of the workpiece with a horizontally clamped tool in the horizontal direction, and FIG. 2c a drilling of the workpiece 10 by means of the tool 15.

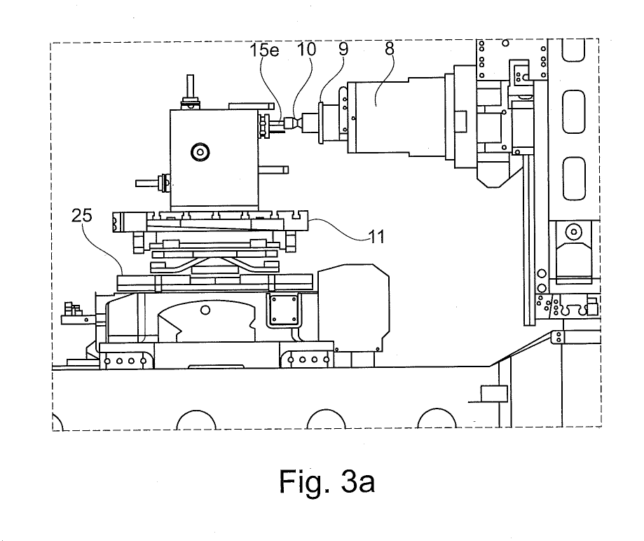

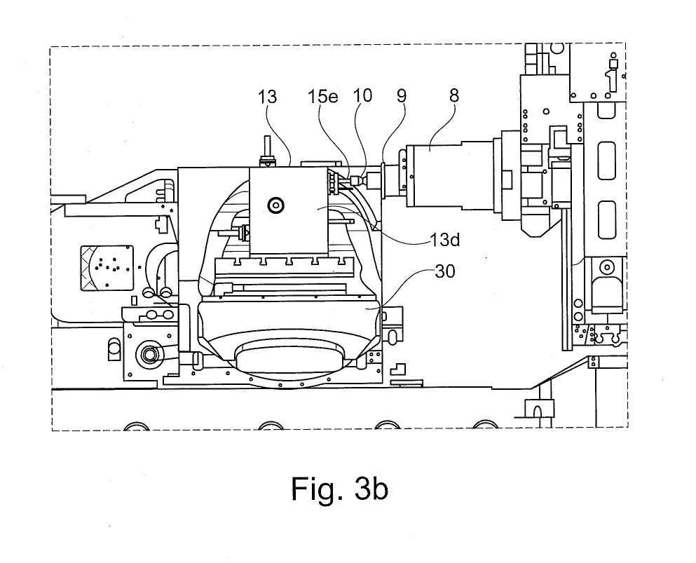

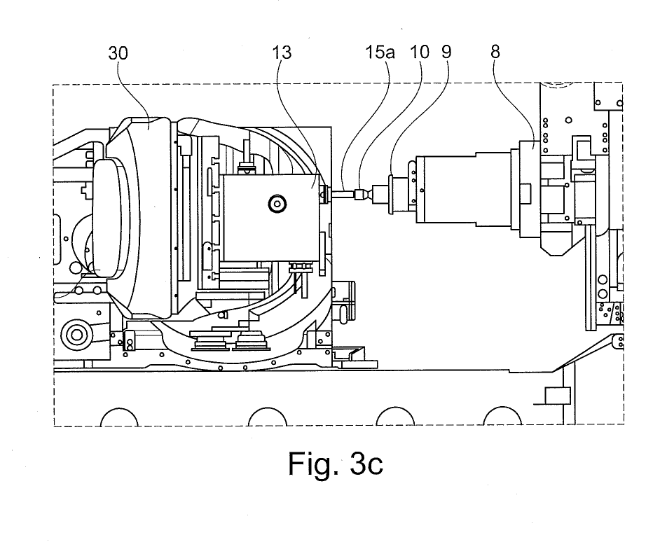

FIG. 3a shows an example in which a tool magazine 13 according to the invention is arranged on a NC circular table 25. By contrast with this, FIGS. 3b and 3c show a configuration of the machine tool according to the invention in which the tool magazine 13 according to the invention is arranged on a swivel rotary table 30, FIG. 3b showing the swivel rotary table in an angle position of 0°, i.e., parallel to the machine bed, while in the representation of FIG. 3c it is tilted by 90°. The representations in FIGS. 3a, b and c show that a machining of the workpiece 10 or 11 clamped in the work spindle 7 is possible by means of different tools 15d (in FIG. 3b) or 15b (in FIG. 1c) with the same relative positioning of the work spindle 7 simply by a 90° swiveling of the swivel rotary table 30.

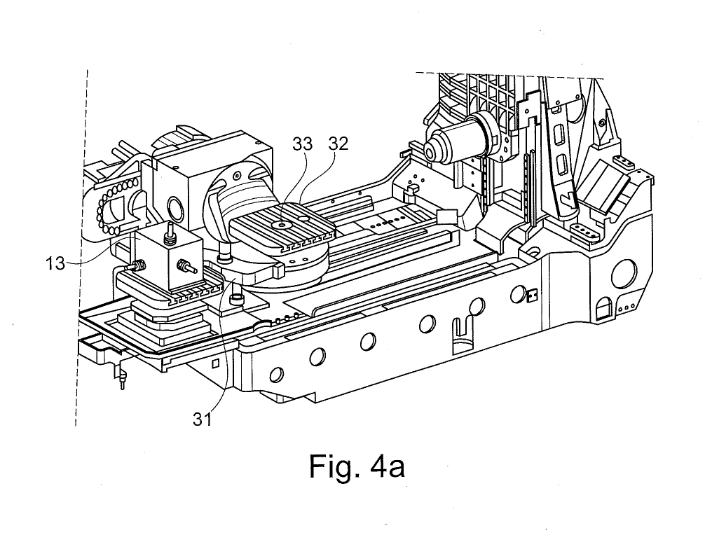

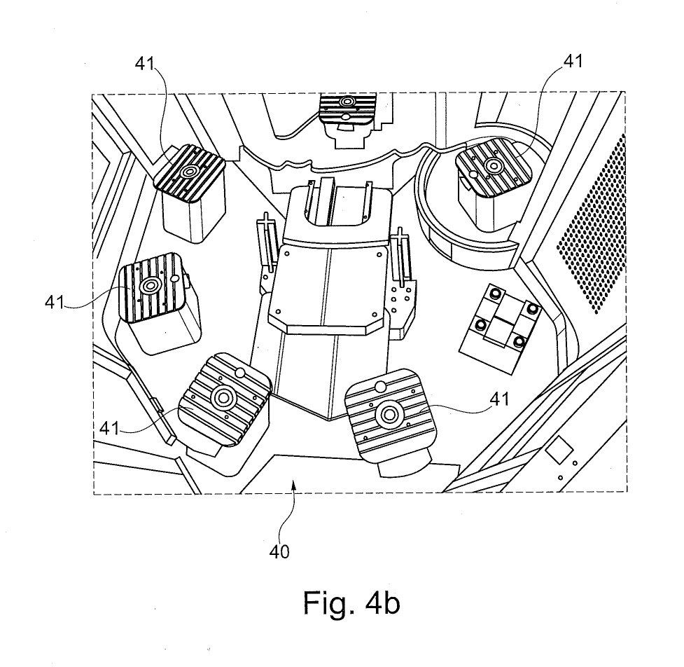

FIG. 4a shows an exemplary embodiment of a machine tool according to the invention in which a pallet changer 31 is provided, by which a change pallet 32 can be swapped. On the change pallet 32 there is provided a clamping means 33 by which either a further tool magazine can be mounted (similar to the tool magazine 13 shown in the representation) or a further corresponding tool can be mounted by a corresponding clamping means such as a tool interface (not shown) for the direct clamping of a tool on this pallet 32. With the round magazine 40 shown in FIG. 4b it is possible to swap other pallets 41 in short succession into the machine tool according to the invention so as to accomplish an automated feeding of pallets preloaded with tools (not shown) via the pallet changer 32.

Of course, the invention is not reduced to pallets as interchangeable tool carriers, and traditional tool carriers may be used just as well, having clamping means for securing a tool magazine according to the invention on them.

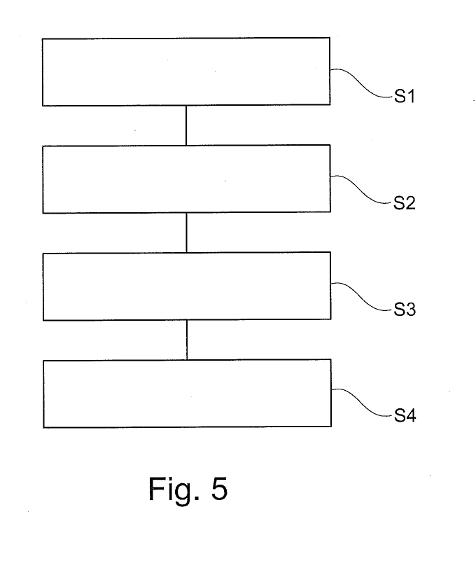

FIG. 5 shows an exemplary embodiment of a method according to the invention with the steps S1 of providing a plurality of workpieces in a magazine and swapping one of the workpieces into the work spindle of the machine tool in step S2. In step S3 there is the providing of a tool magazine with a plurality of tools, mounted on a machine bench of the machine tool, and in step S4 there occurs the machining of the tool clamped in the work spindle with one of the tools stored in the tool magazine.

The above description of the invention in its general form and with the aid of the exemplary embodiments clearly shows how the concept of five-axis machining of workpieces on the machine tool is significantly broadened by the invention, as regards the possibilities of the positioning of tool and workpiece with reduced traversing at the same time. This is accomplished by the combination of the so-called “reverse clamping of workpiece in work spindle and tool on the machine bench” with the tool magazine according to the invention, which consequently uses the available space in the area of the machine bench to make possible the design prerequisites for a providing of different tools in different orientation. With the addition of the further options according to the invention of including a pallet changer with tool magazine clamped on the pallet or a wheel magazine, the possibility of machining in time-efficient manner with shortened feed paths is further increased, so that a substantial reduction in the machining time can be realized in industrial fabrication on the machine tool according to the invention.

1. Machine tool for the machining of a workpiece by means of a tool, wherein the machine tool is designed to clamp the workpiece for the machine-controlled machining within a machining program on the work spindle and to clamp the tool on the machine bench of the machine tool, characterized by
a tool magazine which can be secured on the machine bench, on or at which a tool or a plurality of tools may be clamped individually in a replaceable manner.

2. Machine tool according to patent claim 1, characterized in that the tool magazine is designed so that different tools can be clamped in different directions on the tool magazine.

3. Machine tool according to patent claim 2, characterized in that the tool magazine has a substantially rectangular or cuboidal base body, on whose outer surfaces clamping means are provided for the clamping of the tool or tools.

4. Machine tool according to patent claim 1, characterized in that the tool magazine comprises at least one driving means by which individual or multiple tools can be driven independently of the movement of the machine bench.

5. Machine tool according to patent claim 1, characterized in that the tool magazine comprises a clampable pallet.

6. Machine tool according to patent claim 5, characterized in that the machine tool moreover comprises a pallet changer and a pallet magazine, especially a round or linear magazine, so that the pallet changer in combination with the round or linear magazine can bring about an automated interchanging of a plurality of tools which are clamped on the pallet.

7. Machine tool according to patent claim 1, characterized in that the machine bench is a swivel rotary table.

8. Machine tool according to patent claim 1, characterized in that the machine tool moreover comprises a wheel magazine, which is designed to store a plurality of workpieces and a changing mechanism by means of which the workpieces can be swapped in and out from the wheel magazine to the work spindle.

9. Machine tool according to patent claim 8, characterized in that the wheel magazine is moreover designed to hold tools and the changing mechanism is moreover configured to swap tools in and out from the wheel magazine to the work spindle.

10. Machine tool according to patent claim 1, characterized in that the machine tool is designed to fasten the workpiece to the work spindle by a tool interface, especially a HSK interface.

11. Method for machining a workpiece on a machine tool with the steps:
Providing of a plurality of workpieces in a magazine,
Swapping of one of the workpieces in the work spindle of the machine tool,
Providing of a tool magazine with a tool or a plurality of tools, mounted on a machine bench of the machine tool
And machining of the workpiece clamped in the work spindle with one tool or a succession of several tools kept in the tool magazine.

12. Method for machining a workpiece on a machine tool according to patent claim 11, characterized in that, for the replacing of the tools, the tool magazine with the tools stored therein is replaced by means of a pallet changer for another tool magazine with tools stored therein.

13. Method for machining a workpiece on a machine tool according to patent claim 11, characterized in that tools are also stored in the magazine besides the workpieces and a handling device is used to swap in workpieces and tools in the work spindle in alternating succession and workpieces are also stored in the tool magazine besides tools and the method involves the step of machining a workpiece clamped in the tool magazine by a tool provided in the work spindle.
